(19) United States
(12) Patent Application Publication
(10) Pub. No.: US 2020/0372039 A1
(43) Pub. Date: Nov. 26, 2020

(54) DATA PROCESSING METHOD, APPARATUS, AND SYSTEM

(71) Applicant: Huawei Technologies Co., Ltd., Shenzhen (CN)

(72) Inventors: Yang HU, Xi'an (CN); Zan ZHANG, Xi'an (CN); Zemin LI, Xi'an (CN)

(21) Appl. No.: 16/990,640

(22) Filed: Aug. 11, 2020

Related U.S. Application Data
(63) Continuation of application No. PCT/CN2018/104530, filed on Sep. 7, 2018.

(30) Foreign Application Priority Data
Feb. 11, 2018 (CN) 201810142085.5

(51) Int. Cl. G06F 16/25; G06F 16/2458; G06F 16/22; H04L 29/08

(52) U.S. Cl. CPC G06F 16/254; H04L 67/10; G06F 16/2291; G06F 16/2462

(57) ABSTRACT

Embodiments of the present invention disclose a data processing method including: obtaining, by a distribution server, original data, determining a target type of the original data, determining, based on the target type, a target computing server to which the original data belongs, and sending the original data of the target type by sending a data storage request to the target computing server; and receiving, by the target computing server, the data storage request sent by the distribution server, storing the original data of the target type, and each time a preset aggregation period is reached, determining aggregated data of the target type in a current aggregation period based on original data of the target type that is received in the current aggregation period. By using the present method, efficiency of data statistics processing can be improved.

### CROSS-REFERENCE TO RELATED APPLICATIONS

This application is a continuation of International Application No. PCT/CN2018/104530, filed on Sep. 7, 2018, which claims priority to Chinese Patent Application No. 201810142085.5, filed on Feb. 11, 2018. The disclosures of the aforementioned applications are hereby incorporated by reference in their entireties.

### TECHNICAL FIELD

The present invention relates to the field of computer technologies, and in particular, to a data processing method, apparatus, and system.

### BACKGROUND

A statistical rule for data may be applied to monitoring and analysis of an object. For example, an operating status of a server may be monitored and analyzed by using a statistical rule for central processing unit (CPU) usage of each server in an equipment room, a weather change status of each region may be monitored and analyzed by using a statistical rule for precipitation in the region, an education status of a city may be monitored and analyzed by using a statistical rule for a score of each student in the city, and a national living standard of this year may be monitored and analyzed by using a statistical rule for a salary, of the year, of each citizen in a country.

Data used for monitoring may be randomly stored on a plurality of storage servers. However, when a data amount is comparatively large, storage resources are wasted. Therefore, statistical processing may be performed on the data, and obtained aggregated data is then stored, to reduce overheads of storage resources. Statistics collection methods usually include: collecting statistics on a maximum value, collecting statistics on a minimum value, collecting statistics on an average value, performing summation, collecting statistics on a quantity, and the like. Statistics are collected on a large amount of data that is collected in a period of time, to obtain a maximum value, a minimum value, a sum value, a quantity of data, and the like in the period of time, to obtain aggregated data in the period of time. The aggregated data may reflect a statistical rule for data, and original data may no longer be required for monitoring and analyzing an object. In the prior art, each time a preset aggregation period is reached, a computing server may obtain data of a same type on each storage server through network transmission, and further perform statistical processing on the obtained data to obtain aggregated data.

In a process of implementing the present invention, the inventor finds that the prior art has at least the following problem:

According to the foregoing processing manner, each time statistical processing is performed, the computing server needs to wait for each storage server to transmit data. This process increases a time from triggering to ending of statistical processing, thereby reducing statistical processing efficiency for data.

### SUMMARY

To improve statistical processing efficiency for data, embodiments of the present invention provide a data processing method, apparatus, and system. The technical solutions are as follows.

According to a first aspect, a data processing method is provided. The method is applied to a distribution server, and the method includes: obtaining original data, where the original data includes a parameter value and at least one attribute value; determining a target type of the original data, where an attribute value included in the target type is in the at least one attribute value; determining, based on the target type, a target computing server to which the original data belongs; and sending a data storage request to the target computing server, where the data storage request carries the original data.

In the solution shown in this embodiment of the present invention, when obtaining the original data, the distribution server may distribute, based on the target type of the original data, the original data to the target computing server to which the original data belongs. The distribution server may periodically obtain original data of the target type. Each time the distribution server obtains a piece of original data, the distribution server may determine, based on a target type of the original data, a target computing server to which the original data needs to be distributed, and then may send a data storage request carrying the original data to the target computing server. In this way, original data of a same type may be distributed to a same computing server. When the computing server performs statistical processing, all data on which calculation depends is stored on the computing server, and there is no need to wait for another server to transmit data, thereby improving statistical processing efficiency for data.

In a possible implementation, the determining, based on the target type, a target computing server to which the original data belongs includes: determining a group number of a target group corresponding to the target type, and determining, based on a preset correspondence between a group and a computing server, that a computing server corresponding to the target group is the target computing server to which the original data belongs. The data storage request further carries the group number of the target group.

In the solution shown in this embodiment of the present invention, each time the distribution server receives original data, the distribution server may obtain, through calculation based on a target type of the original data, a target group to which the original data belongs, and then the distribution server may determine, based on the preset correspondence between a group and a computing server, a target computing server corresponding to the target group, where the target computing server is a target computing server to which the original data of the target type belongs. When obtaining the target group to which the original data belongs, the distribution server may further correspondingly add a group number of the target group to a data storage request for the original data.

In a possible implementation, the determining a group number of a target group corresponding to the target type includes: calculating, based on the attribute value included in the target type, the group number of the target group corresponding to the target type.

In the solution shown in this embodiment of the present invention, the target type is converted into a corresponding identifier string, and then the group number of the target group corresponding to the original data of the target type may be calculated based on the identifier string. The identifier string may uniquely represent the target type, so that different group numbers may be calculated for different types of original data.

In a possible implementation, the calculating, based on the attribute value included in the target type, the group number of the target group corresponding to the target type includes: determining a code, of a preset coding type, corresponding to each character in the attribute value included in the target type; calculating, based on each determined code and a preset calculation function, a feature code corresponding to the target type; and performing a modulo operation on the feature code and a total quantity of groups, and determining an obtained remainder as the group number of the target group corresponding to the target type.

In the solution shown in this embodiment of the present invention, each time the distribution server receives original data, the distribution server may convert the original data into a first data tuple in a unified format, then convert each attribute in the first data tuple into a string type, convert each character into a code of a preset coding type, and calculate, by using the preset calculation function, a feature code corresponding to a target type, to represent the target type. A corresponding remainder may be obtained by dividing the feature code by a total quantity of groups, and the remainder is in a one-to-one correspondence with a group number of a group. Therefore, the obtained remainder may be directly determined as a group number of a target group corresponding to the target type, to simplify a correspondence between a remainder and a group number.

In a possible implementation, the preset calculation function includes one of the following functions or a combination function including a plurality of the following functions: a summation function, a differencing function, a product function, and a bitwise AND function.

In the solution shown in this embodiment of the present invention, the feature code corresponding to the target type may be calculated by using different preset calculation functions. Regardless of which calculation function is used, the obtained feature code is used to distinguish the target type from another type.

In a possible implementation, the code of the preset coding type is an American standard code for information interchange (ASCII).

In the solution shown in this embodiment of the present invention, each character may have a unique corresponding ASCII, and an ASCII of each character in a string may be combined to represent a target type.

According to a second aspect, a data processing method is provided. The method is applied to a computing server, and the method includes: receiving a data storage request sent by a distribution server, where the data storage request carries original data, the original data includes a parameter value and at least one attribute value, the original data is of a target type, and an attribute value included in the target type is in the at least one attribute value; storing the original data of the target type; and each time a preset aggregation period is reached, determining aggregated data of the target type in a current aggregation period based on original data of the target type that is received in the current aggregation period.

In the solution shown in this embodiment of the present invention, the computing server may receive, at any time, a data storage request sent by the distribution server, and then may obtain original data carried in the data storage request, and store the original data in a memory. Each time an aggregation period is reached, the computing server may read, from the memory, original data of the target type that is received in the current aggregation period, perform statistical processing on the read original data, and calculate aggregated data of the target type in the current aggregation period. The computing server may receive more than one type of original data, and may perform the foregoing processing on original data of each type, to obtain aggregated data of the type in the current aggregation period. Data on which statistical processing depends no longer needs to occupy network bandwidth for transmission, thereby reducing occupation of network bandwidth.

In a possible implementation, the data storage request further carries a group number of a target group, and the method further includes: storing a group number of a target group corresponding to the target type; and the each time a preset aggregation period is reached, determining aggregated data of the target type in a current aggregation period based on original data of the target type that is received in the current aggregation period includes: each time the preset aggregation period is reached, for each group number, determining the aggregated data of the target type in the current aggregation period based on original data of the target type that is received in the current aggregation period and that corresponds to the group number.

In the solution shown in this embodiment of the present invention, the computing server may further obtain the group number of the target group to which the original data belongs, and store the group number in the memory, where the group number corresponds to the original data. Each time original data needs to be processed, the target computing server may read, based on a group corresponding to a process, original data that corresponds to a group number of the group and that is stored in the memory in a current aggregation period. Then the target computing server performs statistical processing on original data of a same type based on a user-defined aggregation function, to obtain aggregated data of each type in the current aggregation period.

In a possible implementation, the aggregation period includes a plurality of first-level aggregation sub-periods, an i^{th}-level aggregation sub-period includes a plurality of (i+1)^{th}-level aggregation sub-periods, i is any positive integer greater than 1 and less than n, and n is a preset positive integer. The each time a preset aggregation period is reached, for each group number, determining the aggregated data of the target type in the current aggregation period based on original data of the target type that is received in the current aggregation period and that corresponds to the group number includes: each time an n^{th}-level aggregation sub-period is reached, separately obtaining original data that corresponds to each group number and that is received in a current n^{th}-level aggregation sub-period, for each group number, separately performing statistical processing on original data of the target type in the obtained original data corresponding to the group number, to obtain aggregated data of the target type in the current n^{th}-level aggregation sub-period, and storing a group number corresponding to each piece of aggregated data; each time an i^{th}-level aggregation sub-period is reached, separately obtaining aggregated data in all (i+1)^{th}-level aggregation sub-periods that corresponds to each group number and that is obtained in a current i^{th}-level aggregation sub-period, for each group number, separately performing statistical processing on the aggregated data in all the (i+1)^{th}-level aggregation sub-periods that corresponds to the group number, to obtain aggregated data of the target type in the current i^{th}-level aggregation sub-period, and storing a group number corresponding to each piece of aggregated data; and each time a preset aggregation period is reached, separately obtaining aggregated data in all first-level aggregation sub-periods that corresponds to each group number and that is obtained in the current aggregation period, and for each group number, separately performing statistical processing on the aggregated data in all the first-level aggregation sub-periods that corresponds to the group number, to obtain the aggregated data of the target type in the current aggregation period.

In the solution shown in this embodiment of the present invention, each time an n^{th}-level aggregation sub-period is reached, statistical processing on original data is triggered. Further, based on each process, all data in a current group is automatically indexed by using an aggregation function, statistical processing is performed on original data of a same type, to obtain aggregated data of the target type in the current period, and the aggregated data and a corresponding group number are stored in the memory. Each time an i^{th}-level aggregation sub-period is reached, statistical processing on all (i+1)^{th}-level aggregated data in the current period is triggered, to obtain aggregated data of the target type in the current period for each group, and the aggregated data and a corresponding group number are stored in the memory. Each time a preset aggregation period is reached, statistical processing on all first-level aggregated data in the current period is triggered, to obtain aggregated data of the target type in the current period for each group, and the aggregated data and a corresponding group number are stored in the memory. In this way, processing on original data in the preset aggregation period is distributed to each aggregation sub-period, and an amount of data in one calculation is reduced, thereby reducing a processing time of the computing server, and improving statistical processing efficiency for data.

In a possible implementation, the aggregation period includes m first-level aggregation sub-periods, the i^{th}-level aggregation sub-period includes m (i+1)^{th}-level aggregation sub-periods, and m is a preset positive integer.

In the solution shown in this embodiment of the present invention, multiples of aggregation periods at all levels are the same, so that an amount of data used in each statistical calculation is comparatively balanced. Therefore, calculation efficiency and memory usage of each computing server are balanced during data aggregation, and a data aggregation system can operate stably.

In a possible implementation, after the aggregated data corresponding to the current n^{th}-level aggregation sub-period is obtained, the original data that corresponds to each group number and that is received in the current n^{th}-level aggregation sub-period is deleted; after the aggregated data corresponding to the current i^{th}-level aggregation sub-period is obtained, the aggregated data in all the (i+1)^{th}-level aggregation sub-periods that corresponds to each group number and that is obtained in the current i^{th}-level aggregation sub-period is deleted; and after the aggregated data corresponding to the current aggregation period is obtained, the aggregated data in all the first-level aggregation sub-periods that corresponds to each group number and that is obtained in the current aggregation period is deleted.

In the solution shown in this embodiment of the present invention, each time aggregated data is obtained, data on which calculation of the aggregated data depends is deleted, to reduce memory usage.

According to a third aspect, a distribution server is provided. The distribution server includes at least one module, and the at least one module is configured to implement the data processing method provided in the first aspect.

According to a fourth aspect, a computing server is provided. The computing server includes at least one module, and the at least one module is configured to implement the data processing method provided in the second aspect.

According to a fifth aspect, a data processing system is provided. The system includes a distribution server and a computing server.

The distribution server is configured to: obtain original data, where the original data includes a parameter value and at least one attribute value; determine a target type of the original data, where an attribute value included in the target type is in the at least one attribute value; determine, based on the target type, a target computing server to which the original data belongs; and send a data storage request to the target computing server, where the data storage request carries the original data.

The computing server is configured to: receive the data storage request sent by the distribution server, where the data storage request carries the original data, the original data includes the parameter value and the at least one attribute value, the original data is of the target type, and the attribute value included in the target type is in the at least one attribute value; store the original data of the target type; and each time a preset aggregation period is reached, determine aggregated data of the target type in a current aggregation period based on original data of the target type that is received in the current aggregation period.

According to a sixth aspect, a distribution server is provided. The distribution server includes a processor and a memory. The processor is configured to execute an instruction stored in the memory, and the processor executes the instruction to implement the data processing method provided in the first aspect.

According to a seventh aspect, a computing server is provided. The computing server includes a processor and a memory. The processor is configured to execute an instruction stored in the memory, and the processor executes the instruction to implement the data processing method provided in the second aspect.

According to an eighth aspect, a computer-readable storage medium is provided, including an instruction. When the computer-readable storage instructions runs on a distribution server, the distribution server is enabled to perform the method in the first aspect.

According to a ninth aspect, a computer program product including an instruction is provided. When the computer program product runs on a distribution server, the distribution server is enabled to perform the method in the first aspect.

According to a tenth aspect, a computer-readable storage medium is provided, including an instruction. When the computer-readable storage instructions runs on a computing server, the computing server is enabled to perform the method in the second aspect.

According to an eleventh aspect, a computer program product including an instruction is provided. When the computer program product runs on a computing server, the computing server is enabled to perform the method in the second aspect.

The technical solutions provided in the embodiments of the present invention have the following beneficial effects:

In the embodiments of the present invention, after obtaining the original data of the target type, the distribution server may determine, based on the target type, the target computing server to which the original data belongs, and then send the original data of the target type by sending the data storage request to the target computing server. Further, the target computing server may receive the data storage request sent by the distribution server, store the original data of the target type, and each time a preset aggregation period is reached, determine aggregated data of each type in the current aggregation period based on original data of the type that is received in the current aggregation period. In this way, original data of a same type may be distributed to a same computing server. When the computing server performs statistical processing, all data on which calculation depends is stored on the computing server, and there is no need to wait for another server to transmit data, thereby improving statistical processing efficiency for data.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may derive other drawings from these accompanying drawings without creative efforts.

FIG. 1 is a schematic diagram of a framework of a system according to an embodiment of the present invention;

FIG. 2 is a schematic diagram of a structure of a distribution server according to an embodiment of the present invention;

FIG. 3 is a schematic diagram of a structure of a computing server according to an embodiment of the present invention;

FIG. 4 is a flowchart of a data aggregation method according to an embodiment of the present invention;

FIG. 5 is a flowchart of a data aggregation method according to an embodiment of the present invention;

FIG. 6 is a schematic diagram of calculating a group number according to an embodiment of the present invention;

FIG. 7 is a schematic diagram of division of an aggregation period according to an embodiment of the present invention;

FIG. 8 is a schematic diagram of parallel processing according to an embodiment of the present invention;

FIG. 9 is a schematic diagram of binary-tree division of an aggregation period according to an embodiment of the present invention;

FIG. 10 is a schematic diagram of a data aggregation apparatus according to an embodiment of the present invention;

FIG. 11 is a schematic diagram of a data aggregation apparatus according to an embodiment of the present invention; and

FIG. 12 is a schematic diagram of a data aggregation apparatus according to an embodiment of the present invention.

### DESCRIPTION OF EMBODIMENTS

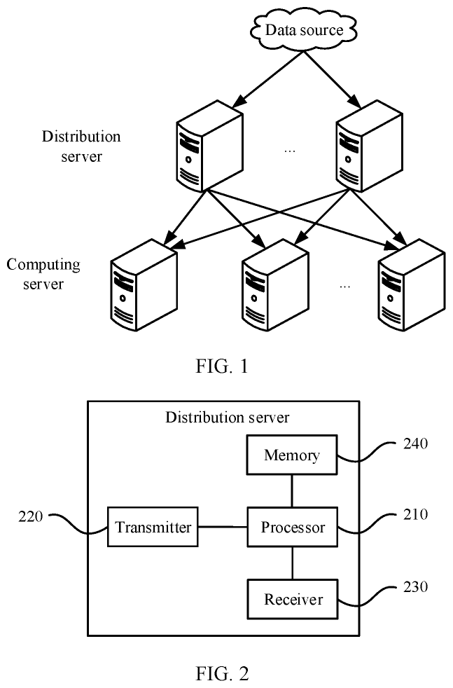

An embodiment of the present invention provides a data processing method. The method may be applied to a data processing system. As shown in FIG. 1, the system may include at least a distribution server and a computing server, and the system may include a plurality of computing servers, and may include one or more distribution servers. A communication connection may be established between the distribution server and the computing server. To avoid that data needs to be transmitted between servers in an aggregate calculation process, after obtaining original data from a data source, the distribution server may distribute original data of a same type to a same computing server, and may distribute original data of each type to each computing server. The computing server may perform statistical processing on the original data to obtain aggregated data. In an actual scenario, corresponding functions of the distribution server and the computing server may be implemented by a same server. The server is a logical distribution server when performing a distribution process, and is a logical computing server when performing a calculation process.

The distribution server may include a processor 210, a transmitter 220, and a receiver 230. The receiver 230 and the transmitter 220 may be separately connected to the processor 210, as shown in FIG. 2. The receiver 230 may be configured to receive a message or data, to be specific, may receive original data sent by another electronic device. The transmitter 220 and the receiver 230 may be network interface cards. The transmitter 220 may be configured to send a message or data, to be specific, may send obtained data to each computing server. The processor 210 may be a control center of the server, and connect various parts of the entire server, such as the receiver 230 and the transmitter 220, by using various interfaces and lines. In the present invention, the processor 210 may be a CPU, and may be used for related processing for determining a target computing server to which the original data belongs. Optionally, the processor 210 may include one or more processing units, and the processor 210 may integrate an application processor and a modem processor. The application processor mainly handles an operating system, and the modem processor mainly handles wireless communication. The processor 210 may be alternatively a digital signal processor, an application-specific integrated circuit, a field programmable gate array, another programmable logic device, or the like. The server may further include a memory 240. The memory 240 may be configured to store a software program and a module. The processor 210 reads software code and the module that are stored in the memory, to perform various function applications and data processing of the server.

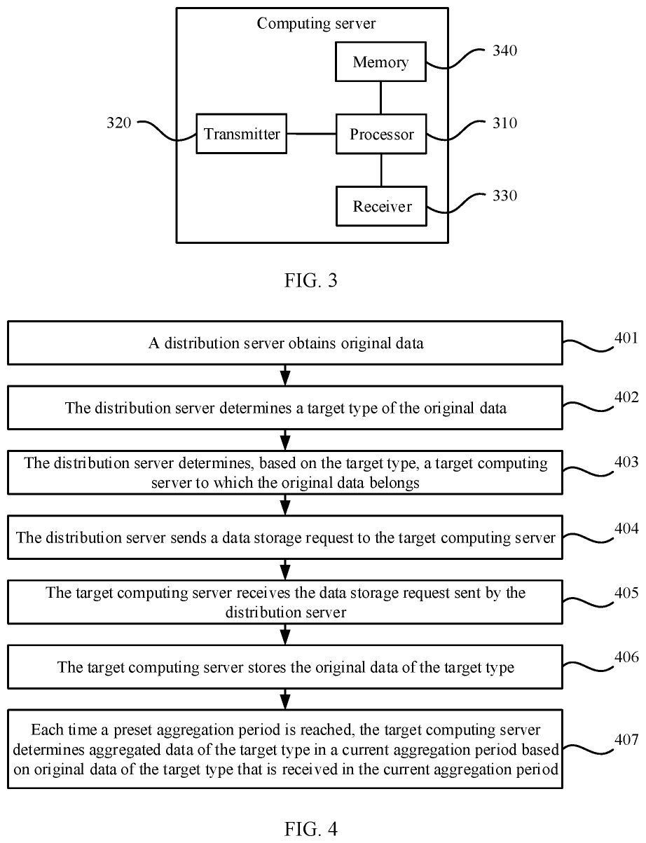

The computing server may include a processor 310, a transmitter 320, and a receiver 330. The receiver 330 and the transmitter 320 may be separately connected to the processor 310, as shown in FIG. 3. The receiver 330 may be configured to receive a message or data, to be specific, may receive original data sent by each distribution server. The transmitter 320 and the receiver 330 may be network interface cards. The transmitter 320 may be configured to send a message or data. The processor 310 may be a control center of the server, and connect various parts of the entire server, such as the receiver 330 and the transmitter 320, by using various interfaces and lines. In the present invention, the processor 310 may be a CPU, and may be used for related processing for determining aggregated data. Optionally, the processor 310 may include one or more processing units, and the processor 310 may integrate an application processor and a modem processor. The application processor mainly handles an operating system, and the modem processor mainly handles wireless communication. The processor 310 may be alternatively a digital signal processor, an application-specific integrated circuit, a field programmable gate array, another programmable logic device, or the like. The server may further include a memory 340. The memory 340 may be configured to store a software program and a module. The processor 310 reads software code and the module that are stored in the memory, to perform various function applications and data processing of the server.

The following describes in detail a flowchart of a data aggregation method shown in FIG. 4 with reference to a specific embodiment. Content may be as follows.

Step 401: A distribution server obtains original data.

The original data is data provided by a data source device for the distribution server, and includes a parameter value and at least one attribute value. To be specific, the original data may include a parameter value on which statistics need to be collected and an attribute value corresponding to the parameter value. A combination of attribute values of the original data may be used to indicate a type of the original data. A target type is a type of original data currently obtained by the distribution server, and an attribute value included in the target type is in at least one attribute value of the original data. In this solution, aggregation processing is performed on original data of a same type. Therefore, in subsequent processing of this solution, original data of a same type is stored on a same computing server for aggregation processing.

Depending on different monitoring requirements, a skilled person may set, for original data, an attribute combination required for statistics collection. For example, a long-term status of a score, in any subject, of any student in any class may be monitored. Original data may be shown in Table 1, and each row corresponds to a piece of original data.

TABLE 1
List of subject scores of students in classes of a school

| Class | Name | Subject | Score |
|---|---|---|---|
| Class 1 | Zhang San | Language | 90 |
| Class 2 | Li Si | Language | 85 |
| Class 1 | Zhang San | Mathematics | 100 |
| Class 1 | Wang Liu | Language | 95 |
| Class 2 | Li Si | Mathematics | 90 |

In Table 1, the class, the name, and the subject are attributes, and the score is a parameter. Class 1 and Class 2 are attribute values of the class attribute. Zhang San, Li Si, and Wang Liu are attribute values of the name attribute. Language and Mathematics are attribute values of the subject attribute. 90, 85, 100, and the like are parameter values of the score parameter. Class 1, Zhang San, and Language form a type, which may be referred to as a type 1; Class 2, Li Si, and Language form another type, which may be referred to as a type 2; Class 1, Zhang San, and Mathematics form a type, which may be referred to as a type 3; and so on. This table records scores of only one exam. For each type, statistics may be collected on scores of a plurality of exams, and the scores of the plurality of exams may be analyzed. For example, Language scores of Zhang San in Class 1 in a plurality of consecutive exams are 76, 79, 82, 86, 88, and 90, that is, scores of the type 1 that are received in a statistics collection process are 76, 79, 82, 86, 88, and 90 in sequence. Further, data of the type 1 may be analyzed, that is, the Language scores of Zhang San in Class 1 are analyzed, and it can be learned that his performance in Language is improving.

For another example, a long-term status of a total score of any student in any class may be monitored. Original data may be shown in Table 2, and each row corresponds to a piece of original data.

TABLE 2
List of scores of students in classes of a school

| Class | Name | Total score |
|---|---|---|
| Class 1 | Zhang San | 602 |
| Class 2 | Li Si | 586 |
| Class 1 | Wang Liu | 627 |

In Table 2, the class and the name are attributes, and the total score is a parameter. Class 1 and Class 2 are attribute values of the class attribute. Zhang San, Li Si, and Wang Liu are attribute values of the name attribute. 602, 586, and 627 are parameter values of the total score parameter. Class 1 and Zhang San form a type, which may be referred to as a type 4; Class 2 and Li Si form another type, which may be referred to as a type 5; Class 1 and Wang Liu form a type, which may be referred to as a type 6; and so on. This table records scores of only one exam. For each type, statistics may be collected on scores of a plurality of exams, and the scores of the plurality of exams may be analyzed. For example, total scores of Zhang San in Class 1 in a plurality of consecutive exams are 580, 585, 610, 596, 572, and 602, that is, total scores of the type 4 that are obtained in a statistics collection process are 580, 585, 610, 596, 572, and 602 in sequence. Further, data of the type 4 may be analyzed, that is, the total scores of Zhang San in Class 1 are analyzed, and it can be learned that he is likely to be admitted to a key university in a national college entrance examination.

For another example, a long-term status of an average Language score of any class may be monitored. Original data may be shown in Table 3, and each row corresponds to a piece of original data.

TABLE 3
List of average Language scores of classes of a school

| Class | Average score |
|---|---|
| Class 1 | 90 |
| Class 2 | 85 |

In Table 3, the class is an attribute, and the average score is a parameter. Class 1 and Class 2 are attribute values of the class. 90 and 85 are parameter values of the average score parameter. Class 1 is a type, which may be referred to as a type 7; Class 2 is a type, which may be referred to as a type 8; and so on. This table records average scores of only one Language exam. For each type, statistics may be collected on average scores of a plurality of Language exams, and the average scores of the plurality of Language exams may be analyzed. For example, average scores of Class 1 in a plurality of consecutive Language exams are 85, 80, 86, 90, 76, and 84, that is, average scores of the type 7 that are obtained in a statistics collection process are 85, 80, 86, 90, 76, and 84 in sequence. Further, data of the type 7 may be analyzed, that is, the average Language scores of Class 1 are analyzed, and it can be learned that the average Language scores of Class 1 are excellent.

In an implementation, the original data may come from various sources. For example, when data used for monitoring is a student's score, the original data may come from data stored on a cloud on a network side; when data used for monitoring is precipitation, the original data may come from data sent by a monitoring device of each monitoring station; or when data used for monitoring is CPU usage and memory usage of a server, the original data may come from the distribution server. It can be learned that there may be various types of original data. In this embodiment of the present invention, original data of one type (that is, a target type) is used as an example. Processing processes for original data of other types are the same, and details are not described again.

For original data of a target type, the distribution server may periodically obtain the original data. For example, each server in an equipment room may collect CPU usage every 10 seconds, and then send the collected CPU usage as original data to the distribution server, so that the distribution server may obtain CPU usage of each server.

A format of the original data obtained by the distribution server may be a text, a resilient distributed dataset (RDD), a java script object notation (JSON), or the like. If monitoring of CPU usage of a server is used as an example, the original data may be “CPU usage of a server 1 is 54%”. The “server 1” and the “CPU usage” are both attribute values of the original data, and “54%” is a parameter value of the original data. To ensure that same data aggregation processing can be performed on original data in various formats, a first data tuple data1=(p₁, p₂, . . . , pₛ, d₁, . . . , dₜ) in a fixed format may be preset, where pᵢ is an i^{th} attribute value in the original data, dⱼ is a j^{th} parameter value in the original data, and a combination of all pᵢ in data1 may be used to indicate a data type.

When receiving a piece of original data, the distribution server may continue to perform a step 402.

Step 402: The distribution server determines a target type of the original data.

In an implementation, based on at least one required attribute that is specified, the distribution server may extract an attribute value of the at least one required attribute from received original data, to obtain a target type of the original data, and then may assign the extracted attribute value to pᵢ of the first data tuple, extract a parameter value, and assign the parameter value to dⱼ. In other words, the original data is converted into the first data tuple in the unified format. For example, the original data in the foregoing example may be converted into data1=(server 1, CPU usage, 54%).

Step 403: The distribution server determines, based on the target type, a target computing server to which the original data belongs.

In an implementation, each time the distribution server obtains a piece of original data, the distribution server may determine, based on a target type of the original data, a target computing server to which the original data needs to be distributed. After undergoing the foregoing processing, original data of a same type may be distributed to a same computing server. Network bandwidth is occupied only in a distribution process, and bandwidth may no longer be occupied in a statistics collection process, thereby reducing network transmission overheads in a calculation process, and shortening a time of an entire data aggregation method process.

Optionally, the original data may be grouped, so that computing servers perform parallel processing on original data of different groups. Corresponding processing may be as follows: determining a group number of a target group corresponding to the target type, and determining, based on a preset correspondence between a group and a computing server, that a computing server corresponding to the target group is the target computing server to which the original data belongs.

In an implementation, a degree of parallelism k is a quantity of processes that can be simultaneously executed in a data aggregation system. The degree of parallelism k of the data aggregation system may be preset based on a total quantity of CPU cores of all computing servers. Usually, the degree of parallelism k is equal to two to three times the total quantity of CPU cores. For example, if there are three computing servers, a CPU of each computing server has four cores, the degree of parallelism k may be set to 24. Further, a total quantity of groups of data may be k, and the groups may be numbered from 0 to k−1, and are respectively used for k processes to process the data in the groups. Then a number of a group for which a computing server needs to perform calculation may be randomly set, or may be set according to a specific rule. This is not limited herein. Then the number of the group and an identifier of the computing server may be added to a correspondence table, to establish a correspondence between the group and the computing server. Further, the correspondence between the group and the computing server is stored on the distribution server. For example, when a computing server 2 is set to process data of a group 2 and a group 3, a correspondence between the group 2 and the computing server 2 and a correspondence between the group 3 and the computing server 2 may be stored on the distribution server.

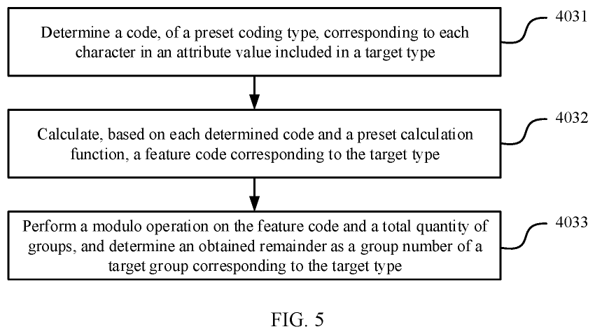

Each time the distribution server receives original data, the distribution server may obtain, through calculation based on a target type of the original data, a target group to which the original data belongs. Optionally, the distribution server may calculate, based on an attribute value included in the target type, a group number of a target group corresponding to the target type. As shown in FIG. 5, specific processing may be as follows.

Step 4031: Determine a code, of a preset coding type, corresponding to each character in the attribute value included in the target type.

The code of the preset coding type may be an ASCII, or may be a code obtained based on a preset character-to-numeral mapping relationship, for example, a code obtained based on a secure hash algorithm (SHA).

Optionally, when the code of the preset coding type may be an ASCII, for the original data of the first data tuple, the distribution server may convert each pᵢ of the first data tuple into a string type, to obtain a plurality of characters of an identifier string corresponding to the attribute value included in the target type. Then the distribution server may convert each character into a corresponding ASCII numeral.

Step 4032: Calculate, based on each determined code and a preset calculation function, a feature code corresponding to the target type.

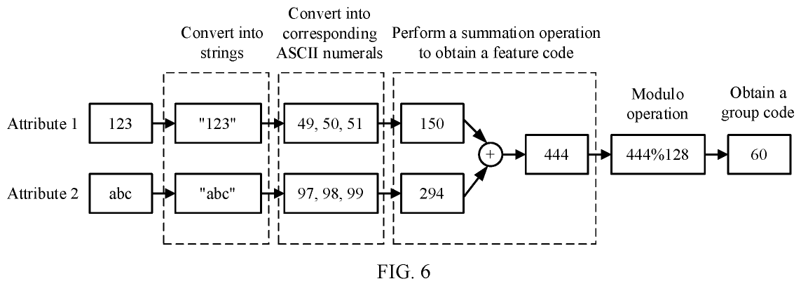

The feature code corresponding to the target type is calculated by using the preset calculation function and based on the ASCII numeral that corresponds to each character and that is determined in the step 4031, to represent the target type. Optionally, the preset calculation function may include one of the following functions or a combination function including a plurality of the following functions: a summation function, a differencing function, a product function, and a bitwise AND function. In a schematic diagram of calculating a group number in FIG. 6, if an attribute of original data includes “123” and “abc”, each attribute may be converted into strings “123” and “abc”. An ASCII numeral corresponding to “1” is 49, “2” corresponds to 50, “3” corresponds to 51, “a” corresponds to 97, “b” corresponds to “98”, and “c” corresponds to 99. A summation operation is performed, to obtain a feature code S corresponding to the target type, where S is 444.

Step 4033: Perform a modulo operation on the feature code and a total quantity of groups, and determine an obtained remainder as the group number of the target group corresponding to the target type.

The corresponding remainder may be obtained by dividing the feature code by the total quantity of groups. As described in the foregoing content of presetting a group number of a group, the total quantity of groups is k, and the group numbers of the groups are 0 to k−1. When the total quantity of groups is used as a divisor, a range of the remainder should be 0 to k−1, which are in a one-to-one correspondence with the group numbers of the groups. Therefore, the obtained remainder may be directly determined as the group number of the target group corresponding to the original data of the target type, to simplify a correspondence between a remainder and a group number. In the schematic diagram of calculating a group number in FIG. 6, the feature code S corresponding to the target type is 444, the total quantity k of groups is equal to 128, and |S| % k=60. In other words, the target group to which the original data of the target type belongs is a group 60.

Further, the distribution server may determine, based on the preset correspondence between a group and a computing server, a target computing server corresponding to the target group, where the target computing server is the target computing server to which the original data of the target type belongs.

For original data of each type, each time the distribution server receives the original data, the distribution server may determine, according to the foregoing process, a computing server to which the original data of the type belongs. Original data of different types may belong to a same computing server or different computing servers. However, an amount of data that needs to be processed by a process can still be effectively reduced, thereby improving processing efficiency of the process.

Step 404: The distribution server sends a data storage request to the target computing server.

In an implementation, after determining, in the foregoing process, the target computing server to which the original data needs to be distributed, the distribution server may send, to the target computing server, the data storage request for storing the original data. The data storage request carries the original data of the target type. The distribution server needs to occupy specific bandwidth only when distributing the original data, and data on which subsequent statistical processing depends no longer needs to occupy network bandwidth for transmission, thereby reducing occupation of network bandwidth.

Optionally, the data storage request may further carry the group number of the target group to which the original data belongs. The data storage request carries original data, and the original data may be alternatively the original data that is converted into the first data tuple in the foregoing process, to facilitate subsequent processing.

Step 405: The target computing server receives the data storage request sent by the distribution server.

In an implementation, the target computing server may receive the data storage request sent by the distribution server, and then may obtain the original data carried in the data storage request. Optionally, the target computing server may further obtain the group number of the target group to which the original data belongs.

Step 406: The target computing server stores the original data of the target type.

In an implementation, the target computing server may store the obtained original data in a memory for subsequent processing. Optionally, the target computing server may further store the group number of the target group corresponding to the target type, that is, store the group number of the target group to which the original data belongs in the memory, where the group number corresponds to the original data.

When an aggregation period starts, the target computing server may receive a data storage request for original data at any time. The steps 405 to 406 are repeatedly performed within the aggregation period, and a step 407 is further performed only when the aggregation period ends.

Step 407: Each time a preset aggregation period is reached, the target computing server determines aggregated data of the target type in a current aggregation period based on original data of each type that is received in the current aggregation period.

In an implementation, Spark is a fast and general-purpose computing engine specially designed for large-scale data processing. Spark may be installed on a computing server, and data may be processed based on Spark. A skilled person may preset an aggregation period in Spark. Each time an aggregation period is reached, the target computing server may read, from the memory, original data of the target type that is received in the current aggregation period, perform statistical processing on the read original data, and calculate aggregated data of the target type in the current aggregation period. For example, the preset aggregation period may be 60 minutes. After a data aggregation program starts to run, each time 60 minutes are reached, a maximum value, a minimum value, an average value, a sum value, a quantity of data, and the like of the CPU usage of the server 1 in the 60 minutes may be obtained. The target computing server may receive more than one type of original data, and may perform the foregoing processing on original data of each type, to obtain aggregated data of the type in the current aggregation period.

Optionally, the target computing server may separately perform parallel processing on original data of each group based on a group to which the stored original data belongs. Corresponding processing may be as follows: each time a preset aggregation period is reached, for each group number, determining aggregated data of the target type in the current aggregation period based on original data of the target type that is received in the current aggregation period and that corresponds to the group number.

In an implementation, the target computing server may process data based on a plurality of processes, and each process corresponds to a group. Each time original data needs to be processed, the target computing server may read, based on a group corresponding to a process, original data that corresponds to a group number of the group and that is stored in the memory in a current aggregation period. For the original data of the first data tuple, each pᵢ of the first data tuple may be combined to obtain a second data tuple, and all attributes are combined to form a unique attribute of the second data tuple. For example, based on the first data tuple data1=(server 1, CPU usage, 54%), a corresponding second data tuple may be obtained: data2=(CPU usage of the server 1, 54%). Then the target computing server performs statistical processing on second data tuples with a same attribute based on a user-defined aggregation function, to obtain aggregated data of each type in the current aggregation period. Then the computing server may further delete original data that has undergone statistical processing, to reduce memory usage.

When data of a plurality of groups is processed based on a plurality of processes, the processes are independent of each other, that is, the data of the groups may be processed simultaneously, thereby improving a degree of parallelism of statistical processing.

When the original data is converted into the format of the first data tuple, no redundant structural information is added to form a DataFrame format. Therefore, an aggregation function inherent in Spark cannot be directly used, and an aggregation function needs to be customized. However, no structural information is used during specific statistical processing. Instead, structural information is used only when the aggregation function inherent in Spark is invoked. Therefore, storing the original data that is converted into the first data tuple can avoid storing redundant structural information, thereby reducing memory overheads and reducing memory usage.

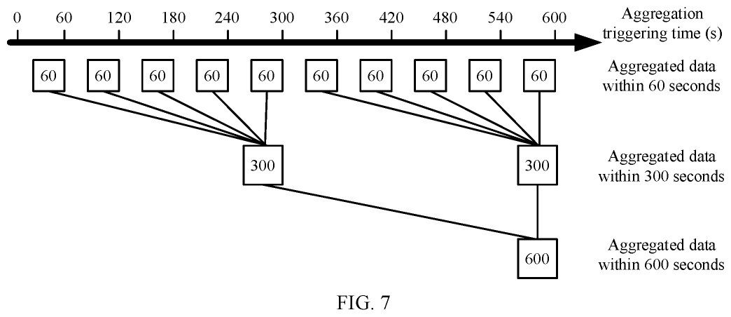

Optionally, the aggregation period may be further divided into multi-level aggregation sub-periods, and aggregated data of an aggregation sub-period with a comparatively long period may be generated based on aggregated data of an aggregation sub-period with a comparatively short period. The aggregation period includes a plurality of first-level aggregation sub-periods, and an i^{th} level aggregation sub-period includes a plurality of (i+1)^{th}-level aggregation sub-periods, where i is any positive integer greater than 1 and less than n, and n is a preset positive integer. All aggregation sub-periods and aggregation periods may be arranged in ascending order, to form an aggregation time sequence {t₀, t₁, . . . , t_{w}}. As shown in a schematic diagram of division of an aggregation period in FIG. 7, a 600-second aggregation period may be divided into two 300-second first-level aggregation sub-periods, and each 300-second first-level aggregation sub-period may be divided into five 60-second second-level aggregation sub-periods. Therefore, an aggregation time sequence may be {60, 300, 600}.

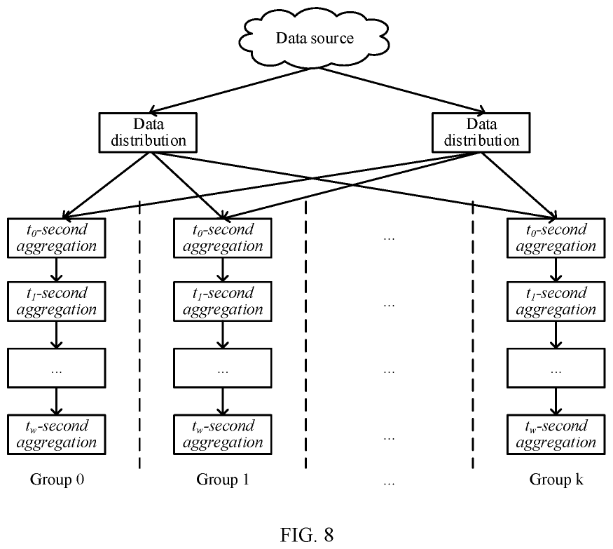

As shown in a schematic diagram of parallel processing in FIG. 8, data of each group is processed independently without mutual interference, and statistical processing may be repeatedly performed based on an aggregation time sequence {t₀, t₁, . . . , t_{w}}. The following describes in detail statistical processing in each aggregation sub-period and aggregation period.

Each time an n^{th}-level aggregation sub-period is reached, the target computing server may separately obtain original data that corresponds to each group number and that is received in a current n^{th}-level aggregation sub-period; for each group number, separately perform statistical processing on original data of the target type in the obtained original data corresponding to the group number, to obtain aggregated data of the target type in the current n^{th}-level aggregation sub-period; and store a group number corresponding to each piece of aggregated data.

In an implementation, period duration of the n^{th}-level aggregation sub-period is the shortest, and data on which calculation depends is original data received in the current period. To be specific, each time an n^{th}-level aggregation sub-period is reached, statistical processing on original data is triggered. Further, based on each process, all data in a current group is automatically indexed by using an aggregation function, statistical processing is performed on parameter values of second data tuples with a same attribute, to obtain aggregated data of the target type in the current period, and the aggregated data and a corresponding group number are stored in the memory for subsequent processing. As shown in the schematic diagram of division of an aggregation period in FIG. 7, the 60-second second-level aggregation sub-period corresponds to the n^{th}-level aggregation sub-period herein, and data on which calculation depends is original data received within current 60 seconds.

Optionally, each time aggregated data of each type in a current n^{th}-level aggregation sub-period is obtained, original data that corresponds to each group number and that is received in the current n^{th}-level aggregation sub-period may be further deleted, that is, data on which current calculation depends is deleted, to reduce memory usage. The obtained aggregated data may be further stored in a database or output to Kafka (a high-throughput distributed publishing/subscription messaging system) for a user to query or use. The aggregated data obtained in the foregoing process may be in a format of a second data tuple. Therefore, before the aggregated data is stored in the database or output to Kafka, the aggregated data may be converted into a format of a first data tuple, that is, an attribute in the second data tuple is split into attributes in an original first data tuple. This can facilitate querying based on different attribute values.

Each time an i^{th}-level aggregation sub-period is reached, the target computing server may separately obtain aggregated data in all (i+1)^{th}-level aggregation sub-periods that corresponds to each group number and that is obtained in a current i^{th}-level aggregation sub-period; for each group number, separately perform statistical processing on the aggregated data in all the (i+1)^{th}-level aggregation sub-periods that corresponds to the group number, to obtain aggregated data of the target type in the current i^{th}-level aggregation sub-period; and store a group number corresponding to each piece of aggregated data.

In an implementation, data on which calculation depends in the i^{th}-level aggregation sub-period is all (i+1)^{th}-level aggregated data obtained in the current period. To be specific, each time an i^{th}-level aggregation sub-period is reached, statistical processing on all (i+1)^{th}-level aggregated data in the current period is triggered, to obtain aggregated data of the target type in the current period for each group, and the aggregated data and a corresponding group number are stored in the memory. A specific process is similar to the foregoing statistical processing performed in the n^{th}-level aggregation sub-period, and details are not described herein again. As shown in the schematic diagram of division of an aggregation period in FIG. 7, the 300-second first-level aggregation sub-period corresponds to the i^{th}-level aggregation sub-period herein. When aggregated data within 300 seconds is calculated, calculation may be performed based on aggregated data of five 60-second periods within the 300 seconds.

Optionally, afterwards, the aggregated data in all the (i+1)^{th}-level aggregation sub-periods that corresponds to each group number and that is obtained in the current i^{th}-level aggregation sub-period may be further deleted, and the obtained aggregated data may be further stored in a database or output to Kafka. Details are not described herein again.

Each time a preset aggregation period is reached, the target computing server may separately obtain aggregated data in all first-level aggregation sub-periods that corresponds to each group number and that is obtained in a current aggregation period; and for each group number, separately perform statistical processing on the aggregated data in all the first-level aggregation sub-periods that corresponds to the group number, to obtain the aggregated data of the target type in the current aggregation period.

In an implementation, period duration of the preset aggregation period is the longest, and data on which calculation depends is all the first-level aggregated data obtained in the current period. To be specific, each time a preset aggregation period is reached, statistical processing on all first-level aggregated data in the current period is triggered, to obtain aggregated data of the target type in the current period for each group. A specific process is similar to the foregoing statistical processing performed in the n^{th}-level aggregation sub-period, and details are not described herein again. As shown in the schematic diagram of division of an aggregation period in FIG. 7, the 600-second aggregation period corresponds to the preset aggregation period herein. When aggregated data within 600 seconds is calculated, calculation may be performed based on aggregated data of two 300-second periods within the 600 seconds.

Optionally, afterwards, the aggregated data in all the (i+1)^{th}-level aggregation sub-periods that corresponds to each group number and that is obtained in the current first-level aggregation sub-period may be further deleted, and the obtained aggregated data may be further stored in a database or output to Kafka. Details are not described herein again. The aggregation period is a preset period with maximum duration, and statistical processing is no longer performed on aggregated data between two aggregation periods. Therefore, after aggregated data of each type in a current aggregation period is stored in the database or output to Kafka, the aggregated data cached in the computing server may be deleted.

In this case, if statistical processing has been performed for each time in the aggregation time sequence, the step 407 may be repeated to perform calculation for a next aggregation period. If the original data in the preset aggregation period is directly processed, an amount of data in one calculation may be comparatively large, and a processing time of the computing server may be comparatively long. However, with processing on the original data in the preset aggregation period being distributed to each aggregation sub-period, an amount of data in one calculation is reduced, thereby reducing a processing time of the computing server, and improving statistical processing efficiency for data.

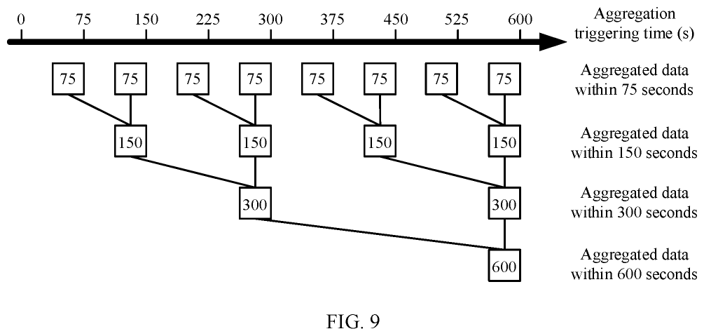

Optionally, the aggregation period may include m first-level aggregation sub-periods, and the i^{th}-level aggregation sub-period may also include m (i+1)^{th}-level aggregation sub-periods, where m is a preset positive integer. In other words, multiples of aggregation periods at all levels are the same. As shown in a schematic diagram of binary-tree division of an aggregation period in FIG. 9, when m is equal to 2, all aggregation sub-periods and a preset aggregation period may constitute a binary-tree form, and each aggregation sub-period may be determined based on the preset aggregation period, that is, tᵢ=2ⁱ×t₀, where tᵢ is any time in the aggregation time sequence {t₀, t₁, . . . , t_{w}}. For example, if the preset aggregation period is 600 seconds, and 600=2³×75, the aggregation time sequence may be {75, 150, 300, 600}.

Further, processing in the step 407 may be performed based on the determined aggregation time sequence, and details are not described herein again. Multiples of aggregation periods at all levels are the same, so that an amount of data used in each statistical calculation is comparatively balanced. Therefore, calculation efficiency and memory usage of each computing server are balanced during data aggregation, and a data aggregation system can operate stably.

If aggregated data obtained for each type of data is stored in the database or output to Kafka, a user may query or invoke the aggregated data based on required attribute information, to analyze a change trend of a corresponding object. For example, the user may query, in the database, a maximum value, a minimum value, an average value, and the like of the CPU usage of the server 1 every 10 minutes in the past one hour.

In this embodiment of the present invention, after obtaining the original data of the target type, the distribution server may determine, based on the target type, the target computing server to which the original data belongs, and then send the original data of the target type by sending the data storage request to the target computing server. Further, the target computing server may receive the data storage request sent by the distribution server, store the original data of the target type, and each time a preset aggregation period is reached, determine aggregated data of the target type in the current aggregation period based on original data of the target type that is received in the current aggregation period. In this way, original data of a same type may be distributed to a same computing server. When the computing server performs statistical processing, all data on which calculation depends is stored on the computing server, and there is no need to wait for another server to transmit data, thereby improving statistical processing efficiency for data.

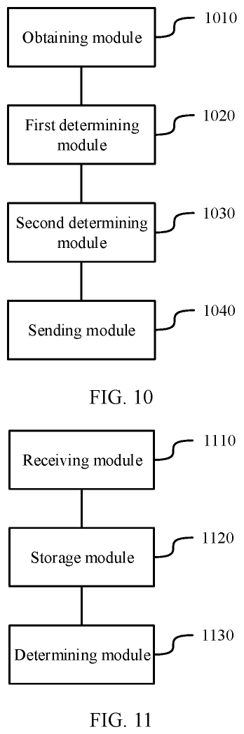

Based on a same technical concept, an embodiment of the present invention further provides a data processing apparatus. The apparatus may be the foregoing distribution server. As shown in FIG. 10, the apparatus includes:

an obtaining module 1010, configured to obtain original data, where the original data includes a parameter value and at least one attribute value, and the obtaining module 1010 may specifically implement the obtaining function in the step 401 and other implicit steps;

a first determining module 1020, configured to determine a target type of the original data, where an attribute value included in the target type is in the at least one attribute value, and the first determining module 1020 may specifically implement the determining function in the step 402 and other implicit steps.

A second determining module 1030, configured to determine, based on the target type, a target computing server to which the original data belongs, where the second determining module 1030 may specifically implement the determining function in the step 403 and other implicit steps; and

a sending module 1040, configured to send a data storage request to the target computing server, where the data storage request carries the original data of the target type, and the sending module 1040 may specifically implement the sending function in the step 404 and other implicit steps.

Optionally, the second determining module 1030 is configured to:

determine a group number of a target group corresponding to the target type, and determine, based on a preset correspondence between a group and a computing server, that a computing server corresponding to the target group is the target computing server to which the original data belongs, where

the data storage request further carries the group number of the target group.

Optionally, the second determining module 1030 is configured to:

calculate, based on the attribute value included in the target type, a group number of a target group corresponding to the original data of the target type.

Optionally, the second determining module 1030 is configured to:

determine a code, of a preset coding type, corresponding to each character in the attribute value included in the target type;

calculate, based on each determined code and a preset calculation function, a feature code corresponding to the target type; and

perform a modulo operation on the feature code and a total quantity of groups, and determine an obtained remainder as the group number of the target group corresponding to the original data of the target type.

Optionally, the preset calculation function includes one of the following functions or a combination function including a plurality of the following functions:

a summation function, a differencing function, a product function, and a bitwise AND function.

Optionally, the code of the preset coding type is an American standard code for information interchange ASCII.

It should be noted that the obtaining module 1010 may be implemented by a transceiver, the first determining module 1020 may be implemented by a processor, the second determining module 1030 may be implemented by a processor, and the sending module 1040 may be implemented by a transceiver.

Based on a same technical concept, an embodiment of the present invention further provides a data processing apparatus. The apparatus may be the foregoing computing server. As shown in FIG. 11, the apparatus includes:

a receiving module 1110, configured to receive a data storage request sent by a distribution server, where the data storage request carries original data, the original data includes a parameter value and at least one attribute value, the original data is of a target type, an attribute value included in the target type is in the at least one attribute value, and the receiving module 1110 may specifically implement the receiving function in the step 405 and other implicit steps;

a storage module 1120, configured to store the original data of the target type, where the storage module 1120 may specifically implement the storage function in the step 406 and other implicit steps; and

a determining module 1130, configured to: each time a preset aggregation period is reached, determine aggregated data of the target type in a current aggregation period based on original data of the target type that is received in the current aggregation period, where the determining module 1130 may specifically implement the determining function in the step 407 and other implicit steps.

Optionally, the data storage request further carries a group number of a target group;

the storage module 1120 is further configured to store a group number of a target group corresponding to the target type; and

the determining module 1130 is configured to: each time a preset aggregation period is reached, for each group number, determine the aggregated data of the target type in the current aggregation period based on original data of the target type that is received in the current aggregation period and that corresponds to the group number.

Optionally, the aggregation period includes a plurality of first-level aggregation sub-periods, an i^{th}-level aggregation sub-period includes a plurality of (i+1)^{th}-level aggregation sub-periods, i is any positive integer greater than 1 and less than n, and n is a preset positive integer. The determining module 1130 is configured to:

each time an n^{th}-level aggregation sub-period is reached, separately obtain original data that corresponds to each group number and that is received in the current n^{th}-level aggregation sub-period, for each group number, separately perform statistical processing on original data of the target type in the obtained original data corresponding to the group number, to obtain aggregated data of the target type in the current n^{th}-level aggregation sub-period, and store a group number corresponding to each piece of aggregated data;

each time an i^{th}-level aggregation sub-period is reached, separately obtain aggregated data in all (i+1)^{th}-level aggregation sub-periods that corresponds to each group number and that is obtained in the current i^{th}-level aggregation sub-period, for each group number, separately perform statistical processing on the aggregated data in all the (i+1)^{th}-level aggregation sub-periods that corresponds to the group number, to obtain aggregated data of the target type in the current i^{th}-level aggregation sub-period, and store a group number corresponding to each piece of aggregated data; and

each time a preset aggregation period is reached, separately obtain aggregated data in all first-level aggregation sub-periods that corresponds to each group number and that is obtained in the current aggregation period, and for each group number, separately perform statistical processing on the aggregated data in all the first-level aggregation sub-periods that corresponds to the group number, to obtain the aggregated data of the target type in the current aggregation period.

Optionally, the aggregation period includes m first-level aggregation sub-periods, the i^{th}-level aggregation sub-period includes m (i+1)^{th}-level aggregation sub-periods, and m is a preset positive integer.

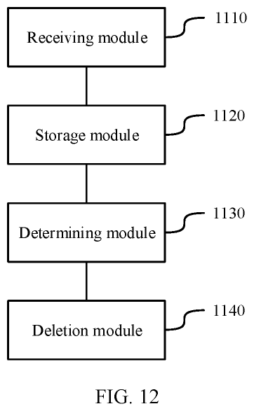

Optionally, as shown in FIG. 12, the apparatus further includes:

a deletion module 1140, configured to: after the aggregated data corresponding to the current n^{th}-level aggregation sub-period is obtained, delete the original data that corresponds to each group number and that is received in the current n^{th}-level aggregation sub-period; after the aggregated data corresponding to the current i^{th}-level aggregation sub-period is obtained, delete the aggregated data in all the (i+1)^{th}-level aggregation sub-periods that corresponds to each group number and that is obtained in the current i^{th}-level aggregation sub-period; and after the aggregated data corresponding to the current aggregation period is obtained, delete the aggregated data in all the first-level aggregation sub-periods that corresponds to each group number and that is obtained in the current aggregation period.

It should be noted that the receiving module 1110 may be implemented by a transceiver, the storage module 1120 may be implemented by a memory, the determining module 1130 may be implemented by a processor, and the deletion module 1140 may be jointly implemented by the processor and the memory.

In this embodiment of the present invention, after obtaining the original data of the target type, the distribution server may determine, based on the target type, the target computing server to which the original data belongs, and then send the original data of the target type by sending the data storage request to the target computing server. Further, the target computing server may receive the data storage request sent by the distribution server, store the original data of the target type, and each time a preset aggregation period is reached, determine aggregated data of the target type in the current aggregation period based on original data of the target type that is received in the current aggregation period. In this way, original data of a same type may be distributed to a same computing server. When the computing server performs statistical processing, all data on which calculation depends is stored on the computing server, and there is no need to wait for another server to transmit data, thereby improving statistical processing efficiency for data.

It should be noted that when the data processing apparatus provided in the foregoing embodiment processes data, division of the foregoing functional modules is used only as an example for description. In actual application, the foregoing functions may be allocated to different functional modules and implemented according to a requirement, in other words, internal structures of the distribution server and the computing server are divided into different functional modules for implementing all or some of the functions described above. In addition, the data processing apparatus provided in the foregoing embodiment and the embodiment of the data processing method belong to a same concept. For details about a specific implementation process of the data processing apparatus, refer to the method embodiment. Details are not described herein again.

Based on a same technical concept, an embodiment of the present invention further provides a data processing system. The system includes a distribution server and a computing server.

The distribution server is configured to: obtain original data, where the original data includes a parameter value and at least one attribute value; determine a target type of the original data, where an attribute value included in the target type is in the at least one attribute value; determine, based on the target type, a target computing server to which the original data belongs; and send a data storage request to the target computing server, where the data storage request carries the original data.

The computing server is configured to: receive the data storage request sent by the distribution server, where the data storage request carries the original data of the target type, the original data includes the parameter value and the at least one attribute value, the original data is of the target type, and the attribute value included in the target type is in the at least one attribute value; store the original data of the target type; and each time a preset aggregation period is reached, determine aggregated data of the target type in the current aggregation period based on original data of the target type that is received in the current aggregation period.

In this embodiment of the present invention, after obtaining the original data of the target type, the distribution server may determine, based on the target type, the target computing server to which the original data belongs, and then send the original data of the target type by sending the data storage request to the target computing server. Further, the target computing server may receive the data storage request sent by the distribution server, store the original data of the target type, and each time a preset aggregation period is reached, determine aggregated data of the target type in the current aggregation period based on original data of the target type that is received in the current aggregation period. In this way, original data of a same type may be distributed to a same computing server. When the computing server performs statistical processing, all data on which calculation depends is stored on the computing server, and there is no need to wait for another server to transmit data, thereby improving statistical processing efficiency for data.

All or some of the foregoing embodiments may be implemented by using software, hardware, firmware, or any combination thereof. When the software is used for implementation, all or some of the embodiments may be implemented in a form of a computer program product. The computer program product includes one or more computer instructions. When the computer program instructions are loaded and executed on a device, the procedures or functions in the embodiments of the present invention are all or partially generated. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial optical cable, an optical fiber, or a digital subscriber line) or wireless (for example, infrared, radio, or microwave) manner. The computer-readable storage medium may be any usable medium accessible by a device, or a data storage device, such as a server or a data center, integrating one or more usable media. The usable medium may be a magnetic medium (for example, a floppy disk, a hard disk, a magnetic tape, or the like), an optical medium (for example, a digital video disk (DVD), or the like), a semiconductor medium (for example, a solid-state drive, or the like).

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely example embodiments of the present invention, but are not intended to limit the present invention. Any modification, equivalent replacement, and improvement made without departing from the spirit and principle of the present invention shall fall within the protection scope of the present invention.

What is claimed is:

1. A data processing method, wherein the method is applied to a distribution server, the distribution server establishes communication connections to a plurality of computing servers, and the method comprises:
obtaining original data comprising a parameter value and at least one attribute value;
determining a target type of the original data from at least one attribute value of the original data;
determining, based on the target type, a target computing server to which the original data belongs; and
sending a data storage request to the target computing server, wherein the data storage request carries the original data.

2. The method according to claim 1, wherein determining the target computing server to which the original data belongs comprises:
determining a group number of a target group associated with the target type, and
determining, based on a preset association between a group and a computing server, that a computing server associated with the target group is the target computing server to which the original data belongs; and
the data storage request further carries the group number of the target group.

3. The method according to claim 2, wherein determining the group number of the target group associated with the target type comprises:
determining, based on the attribute value, the group number of the target group associated with the target type.

4. The method according to claim 3, wherein determining the group number of the target group associated with the target type comprises:
determining a code of a preset coding type associated with each character in the attribute value comprised in the target type;
calculating, based on each determined code and a preset calculation function, a feature code associated with the target type; and
performing a modulo operation on the feature code and a total quantity of groups, and
determining an obtained remainder as the group number of the target group associated with the target type.

5. A data processing method applied to a computing server, wherein the computing server establishes a communication connection to at least one distribution server, and the method comprises:
receiving a data storage request sent by a distribution server, wherein the data storage request carries original data comprising a parameter value and at least one attribute value, and wherein the original data is of a target type determined by at least one attribute value;
storing the original data of the target type; and
each time a preset aggregation period is reached, determining aggregated data of the target type in a current aggregation period based on original data of the target type that is received in the current aggregation period.

6. The method according to claim 5, wherein the data storage request further carries a group number of a target group and the method further comprises:
storing a group number of the target group associated with the target type; and
wherein determining aggregated data of the target type in the current aggregation period comprises:
each time a preset aggregation period is reached, for each group number, determining the aggregated data of the target type in the current aggregation period based on original data of the target type that is received in the current aggregation period and that is associated with the group number.

7. The method according to claim 6, wherein the aggregation period comprises a plurality of first-level aggregation sub-periods, an i^{th}-level aggregation sub-period comprises a plurality of (i+1)^{th}-level aggregation sub-periods, i is any positive integer greater than 1 and less than n, and n is a preset positive integer; and
wherein for each group number, determining the aggregated data of the target type in the current aggregation period comprises:
each time an n^{th}-level aggregation sub-period is reached, separately obtaining original data that is associated with each group number and that is received in a current n^{th}-level aggregation sub-period,
for each group number, separately performing statistical processing on original data of the target type in the obtained original data associated with the group number, to obtain aggregated data of the target type in the current n^{th}-level aggregation sub-period, and storing a group number associated with each piece of aggregated data;
each time an i^{th}-level aggregation sub-period is reached, separately obtaining aggregated data in all (i+1)^{th}-level aggregation sub-periods that is associated with each group number and that is obtained in a current i^{th}-level aggregation sub-period, for each group number, separately performing statistical processing on the aggregated data in all the (i+1)^{th}-level aggregation sub-periods that are associated with the group number, to obtain aggregated data of the target type in the current i^{th}-level aggregation sub-period, and storing a group number associated with each piece of aggregated data; and
each time a preset aggregation period is reached, separately obtaining aggregated data in all first-level aggregation sub-periods associated with each group number and that is obtained in the current aggregation period, and for each group number, separately performing statistical processing on the aggregated data in all the first-level aggregation sub-periods associated with the group number, to obtain the aggregated data of the target type in the current aggregation period.

8. The method according to claim 7, wherein the aggregation period comprises m first-level aggregation sub-periods, the i^{th}-level aggregation sub-period comprises m (i+1)^{th} level aggregation sub-periods, and m is a preset positive integer.

9. The method according to claim 7, wherein after the aggregation data associated with the current n^{th}-level aggregation sub-period is obtained, the method further comprises:
deleting the original data associated with each group number and that is received in the current n^{th}-level aggregation sub-period;
after the aggregation data associated with the current i^{th}-level aggregation sub-period is obtained, the method further comprises: deleting the aggregated data in all (i+1)^{th}-level aggregation sub-periods that are associated with each group number and that is obtained in the current i^{th}-level aggregation sub-period; and
after the aggregation data associated with the current aggregation period is obtained, the method further comprises: deleting the aggregated data in all first-level aggregation sub-periods that are associated with each group number and that is obtained in the current aggregation period.

10. A data processing system is provided, wherein the system comprises a distribution server and a computing server, wherein
the distribution server is configured to:
obtain original data comprising a parameter value and at least one attribute value;
determine a target type of the original data from at least one attribute value of the original data;
determine, based on the target type, a target computing server to which the original data belongs; and
send a data storage request to the target computing server, wherein the data storage request carries the original data; and
the computing server is configured to:
receive the data storage request sent by the distribution server, wherein the data storage request carries the original data comprising the parameter value and the at least one attribute value, the original data is of the target type; store the original data of the target type; and each time a preset aggregation period is reached, determine aggregated data of the target type in a current aggregation period based on original data of the target type that is received in the current aggregation period.

11. A distribution server, wherein the distribution server comprises a processor and a storage device, wherein the processor is configured to perform computer program storing in the storage device to implement the method according to claim 1.
